(19) United States
(12) Patent Application Publication
(10) Pub. No.: US 2013/0050200 A1
(43) Pub. Date: Feb. 28, 2013

(54) OBJECT SEARCH DEVICE, VIDEO DISPLAY DEVICE AND OBJECT SEARCH METHOD

(71) Applicants: Kaoru Matsuoka, Tokyo (JP); Miki Yamada, Tokyo (JP)

(72) Inventors: Kaoru Matsuoka, Tokyo (JP); Miki Yamada, Tokyo (JP)

(73) Assignee: Kabushiki Kaisha Toshiba, Tokyo (JP)

(21) Appl. No.: 13/533,877

(22) Filed: Jun. 26, 2012

(30) Foreign Application Priority Data
Aug. 31, 2011 (JP) 2011-189493

(51) Int. Cl. G06T 15/00; G06K 9/00

(52) U.S. Cl. 345/419; 382/103

(57) ABSTRACT

An object search device has an object searching unit configured to search for an object in a screen frame, an object position correcting unit configured to correct a position of an object area comprising the searched object so that the searched object is located at a center of the object area, an object area correcting unit configured to adjust the area size of the object area so that a background area not including the searched object in the object area is reduced, and a coordinate detector configured to detect a coordinate position of the searched object based on the object area corrected by the object area correcting unit.

### CROSS REFERENCE TO RELATED APPLICATIONS

This application is based upon and claims the benefit of priority from the prior Japanese Patent Application No. 2011-189493, filed on Aug. 31, 2011, the entire contents of which are incorporated herein by reference.

### FIELD

Embodiments of the present invention relate to an object search device for searching an object in a screen frame, a video display device, and an object search method.

### BACKGROUND

A technique for detecting a human face in a screen frame has been suggested. Since the screen frame changes some dozen times per one second, the process of detecting a human face over the entire screen frame area of each frame should be performed at considerably high speed.

Accordingly, a technique for focusing on a color gamut having a strong possibility that an object exists in the screen frame and searching an object in the limited color gamut has been suggested.

However, in this technique, it is difficult to improve the accuracy of object search since some objects are excluded when limiting the color gamut.

Recently, a three-dimensional TV capable of displaying a stereoscopic video has been rapidly popularized, but three-dimensional video data is not widely available as a video source since due to the problems in terms of compatibility with existing TV and its price. Accordingly, in many cases, the three-dimensional TV performs a process of converting existing two-dimensional video data into pseudo three-dimensional video data. In this case, it is required to search a characteristic object in each screen frame of the two-dimensional video data and to add depth information thereto. However, much time is required for the object search process as stated above, and thus there may be a case where much time is not available to generate depth information with respect to each screen frame.

### BRIEF DESCRIPTION OF THE DRAWINGS

FIG. 1 is a block diagram showing an example of a schematic structure of a video display device 2 having an object search device 1.

FIG. 2 is a detailed block diagram showing an example of a depth information generator 7 and a three-dimensional data generator 8.

FIG. 3 is a diagram schematically showing the processing operation performed by the object search device 1 of FIG. 1.

FIG. 4 is a flow chart showing an example of the processing operation performed by an object searching unit 3.

FIG. 5 is a diagram showing an example of a plurality of identification devices connected in series.

FIG. 6 is a flow chart showing an example of the processing operation performed by an object position corrector 4.

FIG. 7 is a flow chart showing an example when broadening an object search area.

FIG. 8 is a flow chart showing an example when narrowing the object search area.

### DETAILED DESCRIPTION

An object search device has an object searching unit configured to search for an object in a screen frame, an object position correcting unit configured to correct a position of an object area comprising the searched object so that the searched object is located at a center of the object area, an object area correcting unit configured to adjust the area size of the object area so that a background area not including the searched object in the object area is reduced, and a coordinate detector configured to detect a coordinate position of the searched object based on the object area corrected by the object area correcting unit.

Embodiments will now be explained with reference to the accompanying drawings.

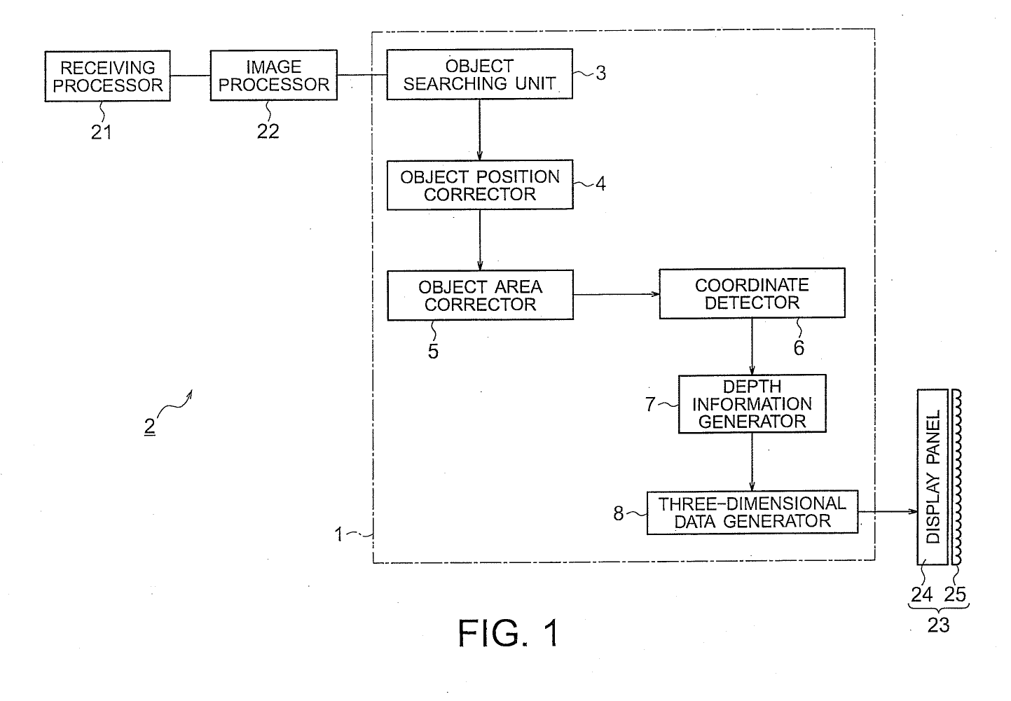

FIG. 1 is a block diagram showing a schematic structure of a video display device 2 having an object search device 1 according to the present embodiment. First, the internal structure of the object search device 1 will be explained.

The object search device 1 of FIG. 1 has an object searching unit 3, an object position corrector 4, an object area corrector 5, a coordinate detector 6, a depth information generator 7, and a three-dimensional data generator 8.

The object searching unit 3 searches an object included in the frame video data of one screen frame. The object searching unit 3 sets a pixel area including the searched object as an object area. When a plurality of objects are included in the screen frame, the object searching unit 3 searches all of the objects, and sets an object area for each object.

The object position corrector 4 corrects the position of the object area so that the object is located at the center of the object area.

The object area corrector 5 adjusts the area size of the object area so that the background area except the object in the object area becomes minimum. That is, the object area corrector 5 optimizes the size of the object area, corresponding to the size of the object.

The coordinate detector 6 detects the coordinate position of the object, based on the object area corrected by the object area corrector 5.

The depth information generator 7 generates depth information corresponding to the object detected by the coordinate detector 6. Then, the three-dimensional data generator 8 generates three-dimensional video data of the object, based on the object detected by the coordinate detector 6 and its depth information. The three-dimensional video data includes right-eye parallax data and left-eye parallax data, and may include multi-parallax data depending on the situation.

The depth information generator 7 and the three-dimensional data generator 8 are not necessarily essential. When there is no need to record or reproduce three-dimensional video data, the depth information generator 7 and the three-dimensional data generator 8 may be omitted.

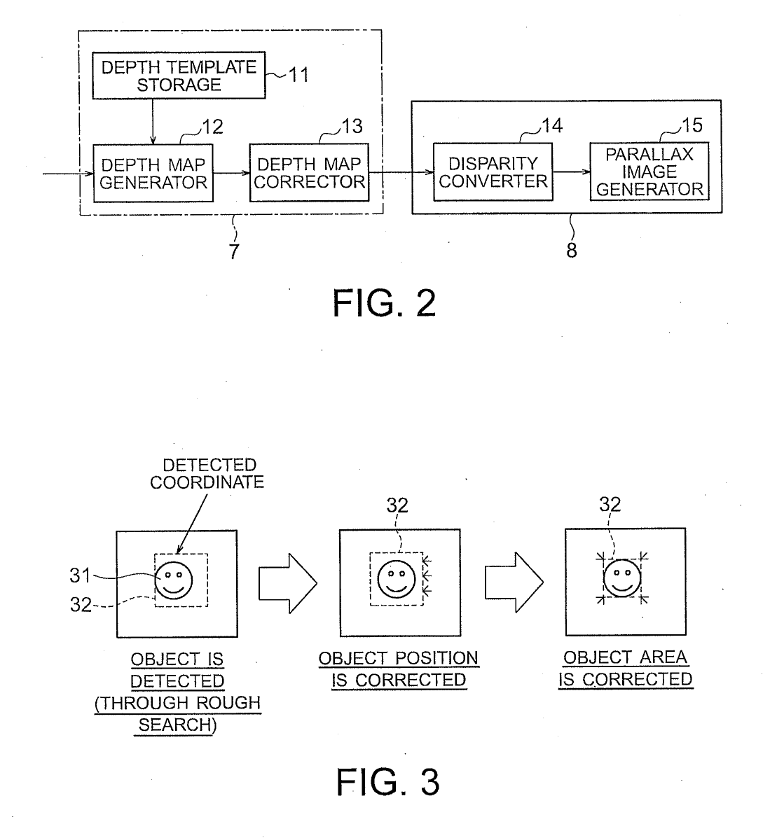

FIG. 2 is a detailed block diagram of the depth information generator 7 and the three-dimensional data generator 8. As shown in FIG. 2, the depth information generator 7 has a depth template storage 11 , a depth map generator 12, and a depth map corrector 13. The three-dimensional data generator 8 has a disparity converter 14 and a parallax image generator 15.

The depth template storage 11 stores a depth template describing the depth value of each pixel of each object, corresponding to the type of each object.

The depth map generator 12 reads, from the depth template storage 11, the depth template corresponding to the object detected by the coordinate detector 6, and generates a depth map relating depth value to each pixel of frame video data supplied from an image processor 22.

The depth map corrector 13 corrects the depth value of each pixel by performing weighted smoothing on each pixel on the depth map using its peripheral pixels.

The disparity converter 14 in the three-dimensional data generator 8 generates a disparity map describing the disparity vector of each pixel by obtaining the disparity vector of each pixel from the depth value of each pixel in the depth map. The parallax image generator 15 generates a parallax image using an input image and the disparity map.

The video display device 2 of FIG. 1 is a three-dimensional TV for example, and has a receiving processor 21, the image processor 22, and a three-dimensional display device 23, in addition to the object search device 1 of FIG. 1.

The receiving processor 21 demodulates a broadcast signal received by an antenna (not shown) to a baseband signal, and performs a decoding process thereon. The image processor 22 performs a denoising process etc. on the signal passed through the receiving processor 21, and generates frame video data to be supplied to the object search device 1 of FIG. 1.

The three-dimensional display device 23 has a display panel 24 having pixels arranged in a matrix, and a light ray controlling element 25 having a plurality of exit pupils arranged to face the display panel 24 to control the light rays from each pixel. The display panel 24 can be formed as a liquid crystal panel, a plasma display panel, or an EL (Electro Luminescent) panel, for example. The light ray controlling element 25 is generally called a parallax barrier, and each exit pupil of the light ray controlling element 25 controls light rays so that different images can be seen from different angles in the same position. Concretely, a slit plate having a plurality of slits or a lenticular sheet (cylindrical lens array) is used to create only right-left parallax (horizontal parallax), and a pinhole array or a lens array is used to further create up-down parallax (vertical parallax). That is, each exit pupil is a slit of the slit plate, a cylindrical lens of the cylindrical lens array, a pinhole of the pinhole array, or a lens of the lens array serves.

Although the three-dimensional display device 23 according to the present embodiment has the light ray controlling element 25 having a plurality of exit pupils, a transmissive liquid crystal display etc. may be used as the three-dimensional display device 23 to electronically generate the parallax barrier and electronically and variably control the form and position of the barrier pattern. That is, a concrete structure of the three-dimensional display device 23 is not limited as long as the display device can display an image for stereoscopic image display (to be explained later).

Further, the object search device 1 according to the present embodiment is not necessarily incorporated into TV. For example, the object search device 1 may be applied to a recording device which converts the frame video data included in the broadcast signal received by the receiving processor 21 into three-dimensional video data and records it in an HDD (hard disk drive), optical disk (e.g., Blu-ray Disc), etc.

FIG. 3 is a diagram schematically showing the processing operation performed by the object search device 1 of FIG. 1. First, as shown in FIG. 3(a), the object searching unit 3 searches an object 31 in the screen frame, and sets an object area 32 so that the searched object 31 is included therein. Next, as shown in FIG. 3(b), the object position corrector 4 shifts the position of the object area 32, and arranges the object 31 at the center of the object area 32. Next, as shown in FIG. 3(c), the object area corrector 5 adjusts the size of the object area 32, and minimizes the background area excepting the object 31 in the object area 32. For example, the object area corrector 5 performs the adjustment so that the outlines of the object area 32 contact with the contours of the object 31.

The coordinate detector 6 detects the coordinate position of the object 31, based on the object area 32 having the size adjusted by the object area corrector 5.

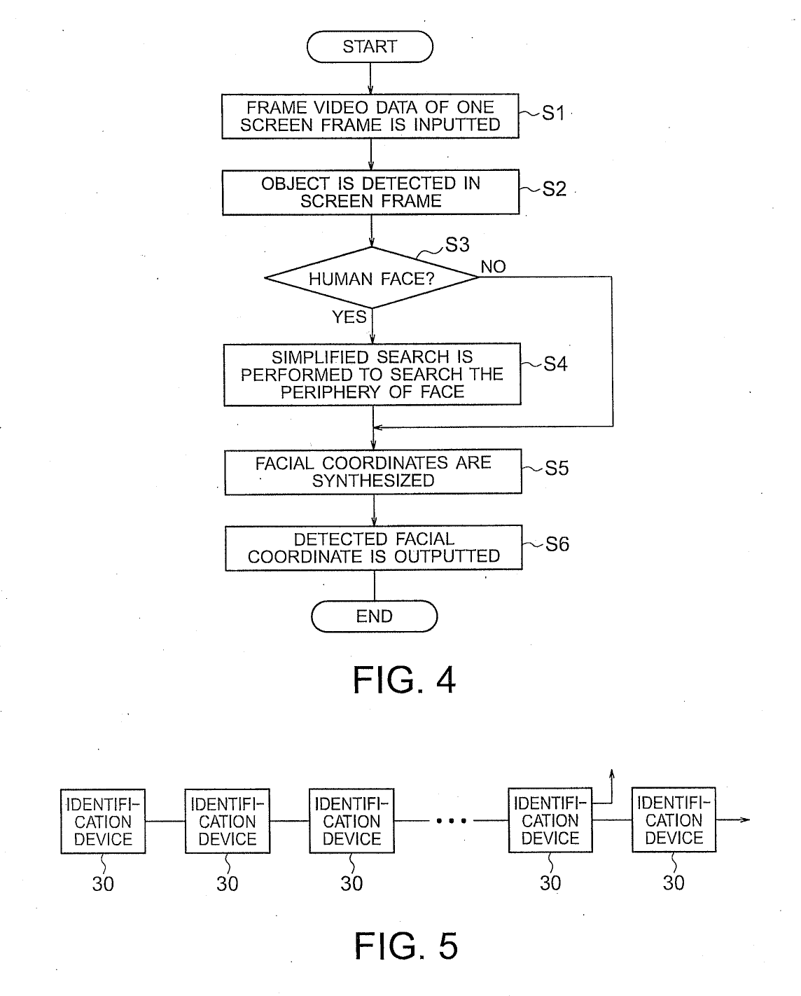

FIG. 4 is a flow chart showing an example of the processing operation performed by the object searching unit 3. First, frame video data of one screen frame is supplied from the image processor (Step S1), and then object search is performed to detect an object (Step S2). Here, a human face is the object to be searched.

When searching a human face, an object detection method using e.g., Haar-like features is utilized. As shown in FIG. 5, this object detection method uses a plurality of identification devices 30 connected in series and each identification device 30 has a function of identifying a human face based on the statistical learning previously performed. Each identification device 30 performs object detection using Haar-like features, setting a pixel area having a predetermined size as a unit of the search area. The result of object detection by the identification device 30 in the former stage is inputted into the identification device 30 in the latter stage, and thus the identification device 30 in the latter stage can search a human face more accurately. Therefore, the identification performance increases as the number of connected identification devices 30 increases, but processing time and implementation area for the identification devices 30 also increase. Therefore, it is desirable that the number of connected identification devices 30 is determined considering acceptable implementation scale and identification accuracy.

Next, whether the detected object is a human face is judged based on the output from the identification devices 30 of FIG. 5 (Step S3).

In the above Step S3, when the object is judged to be a face at a coordinate position (X, Y), a simplified search process is performed in its peripheral area (X−x, Y−y)−(X+x, Y+y) to search the periphery of the face (Step S4). Here, the output from the identification device 30 in the last stage among a plurality of identification devices 30 in FIG. 5 is not used to search a face, and the output from the identification device 30 in the stage preceding the last stage is used to judge whether the object is a human face. Accordingly, there is no need to wait until the identification result is outputted from the identification device 30 in the last stage, which realizes high-speed processing.

When the object is judged to be a human face at a coordinate position (X, Y), the area (X, Y)−(X+a, Y+b) is set as the object area 32 (each of “a” and “b” is a fixed value).

In Step S4, the object searching unit 3 does not perform a detailed search but perform a simplified search to increase processing speed, which is because a detailed search is performed by the object position corrector 4 and the object area corrector 5 later.

When a plurality of human faces exist in the screen frame, the simplified search is performed on every face to detect the coordinate position thereof. Then, a process of synthesizing facial coordinates is performed to detect any similarity by detecting whether overlapping faces exist among a plurality of searched facial coordinates (Step S5).

Here, in the identification devices 30 connected in series in FIG. 5, outputs from the identification devices 30 arranged in the middle stages, not in the last stage, are compared with respect to each overlapping face, in order to select the facial coordinate having the maximum output value as the representative coordinate in each group of overlapping facial coordinates. Then, each of the representative coordinates is outputted as a detected facial coordinate (Step S6). In this way, a pair of overlapping faces are integrated into one.

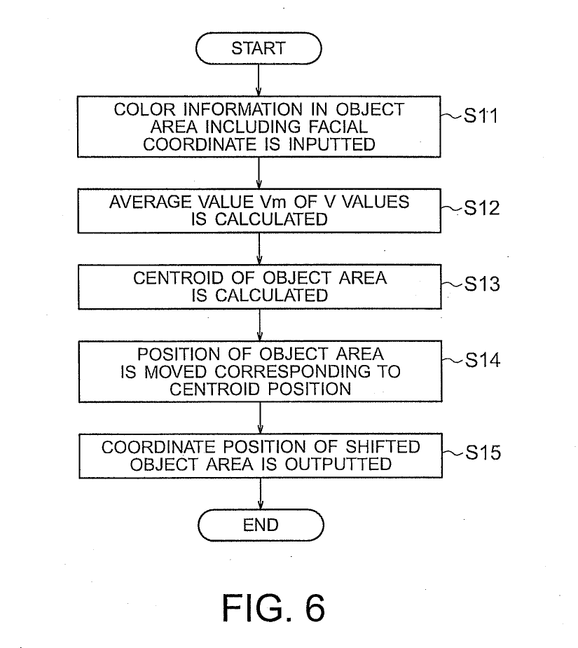

FIG. 6 is a flow chart showing an example of the processing operation performed by the object position corrector 4. First, the object searching unit 3 inputs the color information in the object area (X, Y)−(X+a, Y+b) including the facial coordinate (X, Y) detected by the process of FIG. 4 (Step S11). Next, an average value Vm of V values representing color information in the object area including the face is calculated (Step S12). Here, the V value shows one of YUV serving as three elements representing color space. The Y value represents brightness, the U value represents the blue-yellow axis, and the V value represent the red-cyan axis. The reason why the V value is employed in Step S12 is that red and brightness are important color information to identify a human face.

Computed in the above Step S12 is the average value Vm of V color information values in the area (X+a/2−c, Y+b/2−d)−P(X+a/2+c, Y+b/2+d) near the center of the object search area (X, Y)−(X+a, Y+b). Here, each of “c” and “d” is a value for determining the range of the area near the center of the object area in which the average value is calculated. “c”=0.1×a, and “d”=0.1×b. Note that 0.1 is merely an example number.

Then, the difference between the V value of each pixel in the object area and the average value Vm is calculated, and the centroid (Mean Shift amount) of the object area is calculated using the differential value of each pixel as a weight (centroid calculating unit, Step S13).

Here, centroid Sx in the X direction and centroid Sy in the Y direction can be expressed by the following Formula (1) and Formula (2) respectively.

$$[ Formula 1 ]$$

$$\begin{matrix} {S}_{x} = \frac{{\sum }_{j} ( {e}^{\frac{{( {V}_{j} - {V}_{m} )}^{2}}{- 256}} \times d ( = {x}_{j} - {x}_{c} ) )}{{\sum }_{j} {e}^{\frac{{( {V}_{j} - {V}_{m} )}^{2}}{- 256}}} & ( 1 ) \\ {S}_{y} = \frac{{\sum }_{j} ( {e}^{\frac{{( {V}_{j} - {V}_{m} )}^{2}}{- 256}} \times d ( = {y}_{j} - {y}_{c} ) )}{{\sum }_{j} {e}^{\frac{{( {V}_{j} - {V}_{m} )}^{2}}{- 256}}} & ( 2 )\end{matrix}$$

Next, the position of the object search area is shifted so that the calculated centroid position is superposed on the center of the object area (object area moving unit, Step S14). Then, the coordinate position of the shifted object area is outputted (Step S15).

For example, when the original object area has the coordinate position (X, Y)−(X+a, Y+b), the original object area is shifted to the coordinate position (X+Sx, Y+Sy)−(X+a+Sx, Y+b+Sy) in Step S15.

As stated above, the object position corrector 4 of FIG. 6 shifts the coordinate position of the object area so that the centroid position concerning the color information of the object area including the detected human face and the center of the coordinate of the object area are consistent with each other. That is, the object position corrector 4 shifts only the coordinate position, without changing the size of the object area.

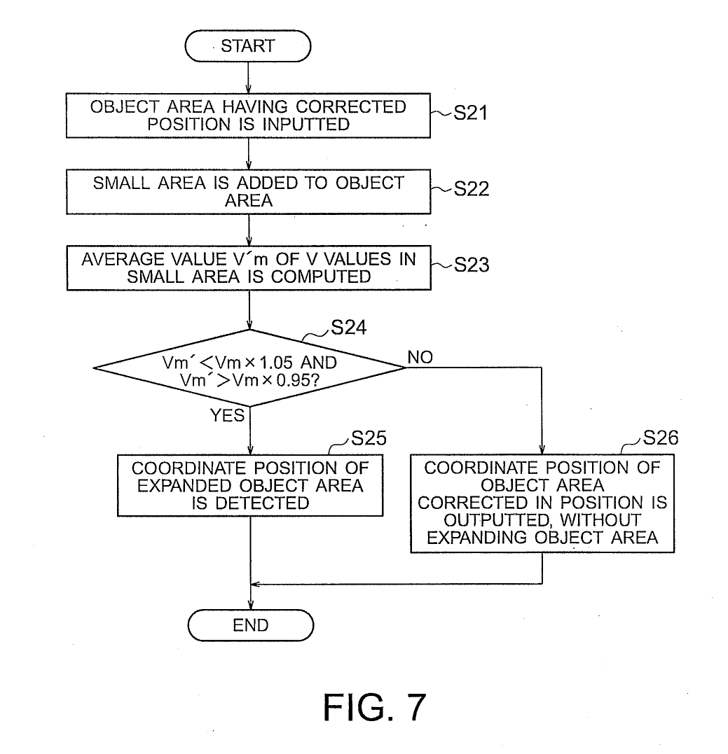

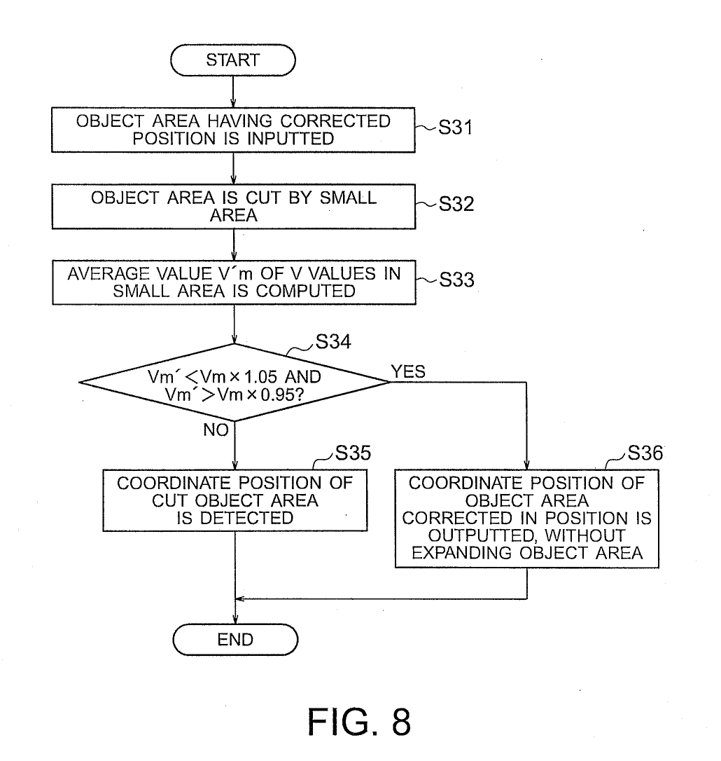

Each of FIG. 7 and FIG. 8 is a flow chart showing an example of the processing operation performed by the object area corrector 5. The flow chart of the object area corrector 5 can be explained from two aspects. FIG. 7 is a flow chart when broadening the object area set by the object searching unit 3, and FIG. 8 is a flow chart when narrowing the object area set by the object searching unit 3.

First, the process of FIG. 7 will be explained. The object area having the coordinate position corrected by the object position corrector 4 is inputted, and the average value Vm of the V values in the corrected object area is calculated (Step S21).

Next, whether the size of the object area can be expanded in the left, right, upper, and lower directions is detected (additional area setting unit, first average color calculating unit, Step S22). Hereinafter, the process of this Step S22 will be explained in detail.

In this case, the coordinate position of the object area is corrected by the object position corrector 4 to the coordinate position (X, Y)−(X+a, Y+b). First, a small area (X−k, Y)−(X, Y+b) is generated on the left side (negative side in the X direction) of the object area, using a sufficiently small value k (Step S22), and an average value V′ m of the V values in this small area is computed (Step S23).

Whether V′ m<Vm×1.05 and V′ m>Vm×0.95 is judged (Step S24), and if V′ m<Vm×1.05 and V′ m>Vm×0.95, a new object area (X−k, Y)−(X+a, Y+b) is generated by expanding the object area by the small area (Step S25). That is, if the V′ m value of the small area is different from the V′ m value of the original object area within a range of 5%, it is judged that information of a human face is included also in the small area, and the small area is added to the object area.

The above process is sequentially performed on the object area with respect to the left side (negative side in the X direction), right side (positive side in the X direction), upper side (positive side in the Y direction), and lower side (negative side in the Y direction), to judge whether the small area can be generated on the left side, right side, upper side, and lower side of the object area. In this case, if the V′ m value in the small area in each direction is different from the V′ m value of the original object area within a range of 5%, the small area in the direction is added to the object area.

In this way, the object area can be expanded to an appropriate size. Then, the coordinate position of the expanded object area is detected (object area updating unit, Step S25).

In FIG. 8, contrary to FIG. 7, whether a small area can be cut inwardly from the upper, lower, left, and right edges of the object area is detected. When the object area having the coordinate position corrected by the object position corrector 4 is inputted (Step S31), the small area is cut inwardly from the upper, lower, left, and right edges of the object area (Step S32), and the average value Vm of the V values in the cut small area is calculated (Step S33). Here, a small area (X, Y)−(X−k, Y) is generated inside from the left edge of the object area, and the average value V′ m of the V values in this small area is computed (Step S33).

Next, whether V′ m<Vm×1.05 and V′ m>Vm×0.95 is judged (Step S34). That is, in this Step S34, whether the size of the object area can be reduced inwardly from the upper, lower, left, and right edges by the small area is detected (cut area setting unit, second average color calculating unit).

If not V′ m<Vm×1.05 and V′ m>Vm×0.95, a new object area (X+k, Y)−(X+a, Y+b) is generated by cutting the object area by the small area (object area updating unit, Step S35). That is, if the V′ m value of the small area is different from the V′ m value of the original object area beyond a range of 5%, it is judged that information of a human face is not included in the small area, and the object area is cut by the small area to narrow the object area.

The above process is sequentially performed on the object area with respect to the left side (negative side in the X direction), right side (positive side in the X direction), upper side (positive side in the Y direction), and lower side (negative side in the Y direction), to judge whether the object area can be cut inwardly from the upper, lower, left, and right edges by the small area. In this case, if the V′ m value in the small area in each direction is different from the V′ m value of the original object area beyond a range of 5%, the object area is cut in the direction by the small area.

In the above embodiment, explanation is given on an example where a human face is detected as an object. However, the present embodiment can be employed when searching various types of objects (e.g., vehicle etc.) other than the human face, as the objects. Since main color information and brightness information differ depending on the type of the object, the U value or Y value can be used instead of the V value to calculate the centroid position of the object area and the average value of the small area, depending on the type of the object.

As stated above, in the present embodiment, when searching an object, simplified search is performed first to set an object area around the object, and then the position of the object area is corrected so that the object is arranged at the center of the object area, and finally the size of the object area is adjusted. In this way, the object area appropriate for the size of the object can be set.

Therefore, when subsequently detecting the motion of the object, the area in which the motion detection should be performed can be minimized since the motion detection is performed based on the object area having an optimized size, which leads to the increase in processing speed.

Further, when generating three-dimensional video data by searching an object in two-dimensional video data and generating depth information of the searched object, the area in which the depth information should be generated can be minimized since the depth information is generated based on the object area having an optimized size, which leads to the reduction in the processing time of generating the depth information.

At least a part of the object search device 1 and video display device 2 explained in the above embodiments may be implemented by hardware or software. In the case of software, a program realizing at least a partial function of the object search device 1 and video display device 2 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the object search device 1 and video display device 2 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An object search device, comprising:
an object searching unit configured to search for an object in a screen frame;
an object position correcting unit configured to correct a position of an object area comprising the searched object so that the searched object is located at a center of the object area;
an object area correcting unit configured to adjust the area size of the object area so that a background area not including the searched object in the object area is reduced; and
a coordinate detector configured to detect a coordinate position of the searched object based on the object area corrected by the object area correcting unit.

2. The object search device of claim 1,
wherein the object position correcting unit comprises:
a centroid calculating unit configured to calculate a centroid position of the object area; and
an object area moving unit configured to move the object area so that the center of the object area is consistent with the centroid position calculated by the centroid calculating unit.

3. The object search device of claim 2,
wherein the centroid calculating unit is configured to calculate a centroid position concerning color information of the object area.

4. The object search device of claim 1,
wherein the object searching unit is configured to search a human face as the object by using Haar-like features.

5. The object search device of claim 1,
wherein the object area correcting unit comprises:
an additional area setting unit configured to set a new object area by adding an additional area around the object area;
a first average color calculating unit configured to calculate average colors of both the additional area and the object area; and
a first object area updating unit configured to employ the new object area when an absolute value of a difference between the average colors calculated by the first average color calculating unit is a value or smaller.

6. The object search device of claim 1,
wherein the object area correcting unit comprises:
a cut area setting unit configured to set a new object area by cutting a peripheral area of the object area;
a second average color calculating unit configured to calculate average colors of both the peripheral area and the object area; and
a second object area updating unit configured to employ the new object area when an absolute value of a difference between the average colors calculated by the second average color calculating unit is a value or smaller.

7. The object search device of claim 1, further comprising:
a depth information generator configured to generate depth information of the object having the coordinate position detected by the coordinate detector; and
a three-dimensional data generator configured to generate parallax data for three-dimensionally displaying the object based on the depth information corresponding thereto generated by the depth information generator.

8. A video display device, comprising:
a receiving processor configured to receive a broadcast wave and perform a decoding process and image processing thereon to generate frame video data;
a display configured to display parallax data; and
an object search device,
the object search device comprising:
an object searching unit configured to search an object in a screen frame;
an object position correcting unit configured to correct a position of an object area comprising the searched object so that the searched object is located at a center of the object area;
an object area correcting unit configured to adjust area size of the object area so that a background area not including the searched object in the object area is reduced; and
a coordinate detector configured to detect a coordinate position of the searched object based on the object area corrected by the object area correcting unit,
wherein the object searching unit is configured to search the object in divisional frame video data by dividing the frame video data into a plurality of data blocks.

9. The video display device of claim 8,
wherein the object position correcting unit comprises:
a centroid calculating unit configured to calculate a centroid position of the object area; and
an object area moving unit configured to move the object area so that the center of the object area is consistent with the centroid position calculated by the centroid calculating unit.

10. The video display device of claim 9,
wherein the centroid calculating unit is configured to calculate a centroid position concerning color information of the object area.

11. The video display device of claim 8,
wherein the object searching unit is configured to search a human face as the object by using Haar-like features.

12. The video display device of claim 8,
wherein the object area correcting unit comprises:
an additional area setting unit configured to set a new object area by adding an additional area around the object area;
a first average color calculating unit configured to calculate average colors of both the additional area and the object area; and
a first object area updating unit configured to employ the new object area when an absolute value of a difference between the average colors calculated by the first average color calculating unit is a value or smaller.

13. The video display device of claim 8,
wherein the object area correcting unit comprises:
a cut area setting unit configured to set a new search area by cutting a peripheral area of the object area;
a second average color calculating unit configured to calculate average colors of both the peripheral area and the object area; and
a second object area updating unit configured to employ the new object area when an absolute value of a difference between the average colors calculated by the second average color calculating unit is a value or smaller.

14. The video display device of claim 8, further comprising:
a depth information generator configured to generate depth information of the object having the coordinate position detected by the coordinate detector; and
a three-dimensional data generator configured to generate parallax data for three-dimensionally displaying the object based on the depth information corresponding thereto generated by the depth information generator.

15. An object search method, comprising:
searching an object in a screen frame;
correcting a position of an object area comprising the searched object so that the searched object is located at a center of the object area;
adjusting area size of the object area so that a background area not including the searched object in the object area is reduced; and
detecting a coordinate position of the object based on the corrected object area.

16. The method of claim 15,
wherein the correcting the position of the object area comprises:
calculating a centroid position of the object area; and
moving the object area so that the center of the object area is consistent with the calculated centroid position of the object area.

17. The method of claim 16,
wherein the calculating the centroid position comprises calculating the centroid position concerning color information of the object area.

18. The method of claim 15,
wherein the searching the object comprises searching a human face as the object by using Haar-like features.

19. The method of claim 15,
wherein the correcting the position of the object search area comprises:
setting a new object area by adding an additional area around the object search area;
calculating average colors of both the additional area and the object area; and
employing the new object area when an absolute value of a difference between the calculated average colors is a value or smaller.

20. The method of claim 15,
wherein the correcting the object area comprises:
setting a new object area by cutting a peripheral area of the object area;
calculating average colors of both the peripheral area and the object area; and
employing the new object area when an absolute value of a difference between the calculated average colors is a value or smaller.
